(19) United States
(12) Patent Application Publication
(10) Pub. No.: US 2006/0212314 A1
(43) Pub. Date: Sep. 21, 2006

(54) Integrated response system

(76) Inventor: James T. Ramsey, Virginia Beach, VA (US)

Correspondence Address: SETO PATENTS, 406 RIVERLAND DR., SALEM, VA, 24153, US

(21) Appl. No.: 11/362,570

(22) Filed: Feb. 27, 2006

Related U.S. Application Data
(60) Provisional application No. 60/662,537, filed on Mar. 17, 2005.

(51) Int. Cl. G06Q 10/00

(52) U.S. Cl. 705/2

(57) ABSTRACT

A system for reminding a patient of their doctor's instructions. In the preferred embodiment, the initial data entry is a fax from the doctor's office. The system receives the fax in a fax server and uses an image processor to extract relevant information. The relevant information is sent to a relational database where the relational database builds a record for the patient. The patient's record includes instruction information, which relates to “when” reminder messages are to be sent to the patient and “what” is to be included in the reminder messages. The instruction information is sent to an automated, outbound telephone dialer that in accordance with the instructions places telephone calls to the patient, at pre-defined times, and plays at least one pre-recorded message for the patient to hear.

The present invention was originally disclosed in U.S. provisional patent application Ser. No. 60/662,537 filed on Mar. 17, 2005, and priority is claimed to the provisional patent application.

### BACKGROUND OF THE INVENTION

The present invention relates generally to the field of health care and more specifically to a system that reminds patients of their doctors' orders.

A visit to the doctor may be quick and simple, such as when a patient goes in for a routine check-up and no abnormalities are found. However, a visit to the doctor's office may also be complicated and end with the patient being presented with an overwhelming amount of information, such as when the patient is prescribed more than one medication and each medication has a separate set of rules that must be followed. Many times when a patient is told for the first time that they have a disease and must start medication immediately, the patient is still processing the information related to the diseases while the doctor is presenting the information related to the treatment. Thus, the patient may miss important information, such as instructions for taking the prescribed medications, while in the doctor's office. To make memorization of the doctor's instructions even more difficult is the use of medical terminology, much of which the patient may be hearing for the first time. While many instructions relating to dosing cant be printed on the bottles of the medications, other instructions, such as follow-up visits, specialists to consult and dietary restrictions, are often lost and forgotten shortly after the visit to the doctor. Some doctors' offices will call patients to remind them of follow up visits. However, the personnel in most doctors' offices are too busy with patients that are actually in the office to call past patients to check if they are following all of the doctor's instructions.

What is needed in the field is a system that assists patients with remembering important medical instructions from their doctor. The ideal system would, in response to a simple input from the doctor's office, automatically contact the patient at pre-defined times so that the patient would be given timely reminders of their doctor's instructions.

### SUMMARY OF THE INVENTION

A system for reminding a patient of their doctor's instructions. In response to the doctor filling out and faxing an action form, the system causes one or more reminder messages to be sent to the patient at pre-defined times. The system comprises a fax server, an image processor, a relational database and an automated, outbound telephone dialer. The fax server is adapted for connection to a telephone line, and receives the action form from the doctor's fax machine in the form of image data, which it then converts into an image file. The image processor is connected to the fax server, and receives the image file from the fax server. The image processor uses recognition software to identify multiple informational fields within the image file. The relational database is connected to the image processor, and receives the informational fields from the image processor. The relational database creates a record for the patient and uses the informational fields to populate the patient's record. The automated, outbound telephone dialer is connected to the relational database and receives instructions from the relational database. In response to the instructions, the automated telephone dialer places one or more telephone calls to a telephone of the patient at pre-defined times. Upon connection of each telephone call, the automated dialer plays at least one pre-recorded message for the patient to hear, wherein each pre-recorded message includes at least one reminder to the patient regarding the doctor's instructions.

The fax server can also be adapted for connection to more than one telephone line. Preferably, the image file created by the fax server is a .tif image file and the recognition software used by the image processor includes optical character recognition (OCR) software, image character recognition (ICR) software, and o m [PLEASE PROVIDE WHAT “O” AND “M” STAND FOR] recognition (OMR) software. After the relational database creates the patent's record, the database adds additional fields to the patient's record that assist in scheduling of the one or more telephone calls to the patient. The automated, outbound telephone dialer includes a compliance module that records a date, a time and other information regarding each successfully completed telephone call.

In an alternate embodiment, the automated, outbound telephone dialer is replaced with a second fax server and the second fax server receives the instructions from the relational database. In response to the instructions, the second fax server sends one or more fax transmissions to a fax machine of the patient at pre-defined times, wherein each fax transmission includes at least one reminder for the patient regarding the doctor's instructions. The second fax server also includes a compliance module that records a date, a time and other information regarding each successfully completed fax transmission.

In another embodiment, the automated, outbound telephone dialer is replaced with a web server and the web server receives the instructions from the relational database. In response to the instructions the web server sends one or more e-mail messages to a computer of the patient at pre-defined times, wherein each e-mail message includes at least one reminder for the patient regarding the doctor's instructions.

It is an object of the present invention to help patients remember instructions from their doctors.

It is another object of the present invention to provide a system that in response to a single fax transmission will generate multiple telephone calls to a patient, wherein at least one reminder message is played for the patient during each telephone call.

It is yet another object of the invention to provide a flexible system that will accept multiple types of data entry from the doctor and will also generate multiple types of reminder message for the patient.

### BRIEF DESCRIPTION OF THE DRAWINGS

The invention of the present application will be described in detail with reference to the accompanying drawing(s), given only by way of example, in which:

FIG. 1 is a block diagram showing the preferred embodiment;

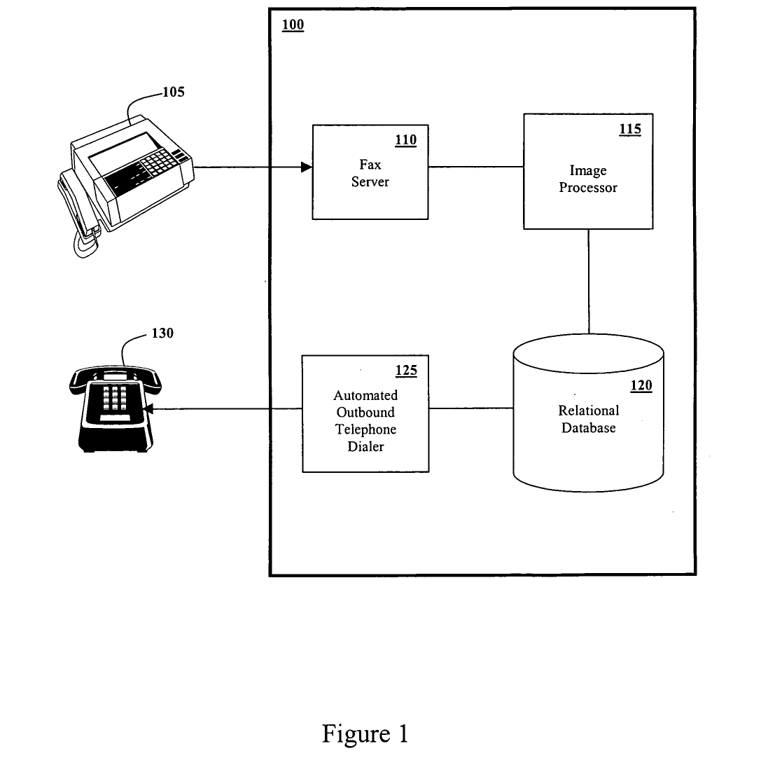

FIG. 2 is a block diagram showing an alternative embodiment;

FIG. 3 is a block diagram showing a generic set up for the present invention;

FIG. 4 shows the capabilities of the four sub-systems in preferred embodiment; and,

FIG. 5 shows an exemplary action form that can used with the preferred embodiment.

### DETAILED DESCRIPTION OF THE INVENTION

In the preferred embodiment, the present invention insures that patients receive vital reminder messages from their doctor. The preferred embodiment 100 is an automated system comprising a series of four sub-systems that are designed to increase patient awareness and compliance to any information, order or instruction given by the patient's doctor. The series of automated sub-systems 110, 115, 120 and 125 are triggered by a single, initial data entry process. In the preferred embodiment, the initial data entry process is a facsimile (fax) transmitted from a fax machine 105 in the doctor's office. The fax form, or action form, which prescribes the placement of specific information about the patient, can be provided to the doctor's office. The transmission from the doctor's fax machine 105 is received by the first sub-system, the Fax Server (FS) 110. The FS 110 receives the image data over a telephone line and converts the image data into a .tif image file that is comparable to the original fax image. The .tif image file is stored in the FS 110 for future record. After the image file has been stored in the FS 110, the data is copied to the second sub-system, the Image Processor (IP) 115. In the IP 115 specific information in the .tif file is recognized using a series of OCR, ICR and/or OMR software. The image file goes through the series of character recognition systems and desired fields in the tif imaged document are identified including, but not limited to, document number, telephone number and various other informational fields. The informational data extracted from the original fax is then populated into the third sub-system, the Relational Database (RD) 120. The RD 120 is the system that houses the patients' database record. The RD 120 creates a record for each image file received through the FS 110 and IP 115. The record is dated and populated into the RD 120 where a series of additional fields are added to assist in the scheduling of the telephone calls. The forth sub-system is the Automated, Outbound, Telephone Dialer (AOTD) 125. The AOTD 125 is the system that performs the dialing of the patient's telephone number and the playing of one or more pre-recorded messages over the telephone line for the patient to hear. The process is designed to assist in reminding patients of their doctor's orders and instructions. The number of telephone calls and the frequency of the calls are determined by the RD 120 and the fields created in that sub-system.

After each of the calls scheduled in the RD 120 sub-system have been successfully made and the required messages played, the date and time is recorded in the AOTD 125 for reporting and compliance statistics. The present automated system also allows for the termination of the scheduled calls. Termination of calls can be accomplished by having the doctor's office re-fax the patient's form back into the Fax Server 110. This action will indicate to the system that the physician's order has been completed. When the IP 115 receives data from the FS 110, it initially searches for a duplicate file in the RD 120 that matches both the record form number and phone number. When a match is found, the calls will be terminated and a record will be created to indicate the desired response was achieved at a specific date and time, as well as compliance statistics.

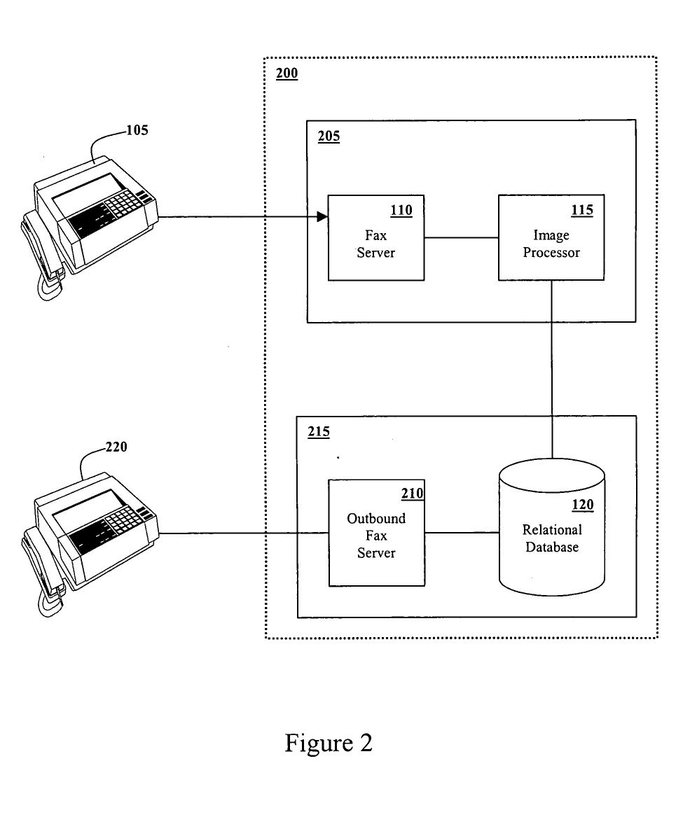

FIG. 2 shows an alternative embodiment 200 in which the four sub-systems are not all physically within the same unit, and the fourth sub-system is now a second fax server 210, vice an automated, outbound telephone dialer. In this embodiment 200, reminder messages are faxed to the patient and printed out on the patient's fax machine 220. Further, in this embodiment, the first two sub-systems, the first Fax Server 110 and Image Processor 115, are physically located in a first unit 205, and the second two sub-systems, the Relational Database 120 and the second Fax Server 210 are co-located in a second unit 215. The connection between the two units 205 & 215 can be as short as a few inches or feet, if a direct connection is being used. However, the distance between sub-units 205 & 215 can also be measured in miles, if a network is used to connect the sub-units. While each sub-unit 205 & 210 contain two sub-systems in FIG. 2, other embodiments include the use of other configurations of units and other numbers of sub-systems in the units. For example, when the initial data entry is a form from a website, the Image Processor sub-system is not needed and therefore, not include in that embodiment. In yet another alternative embodiment, the second Fax Server 210 is replaced by with web server and e-mail reminder messages are transmitted to the patient.

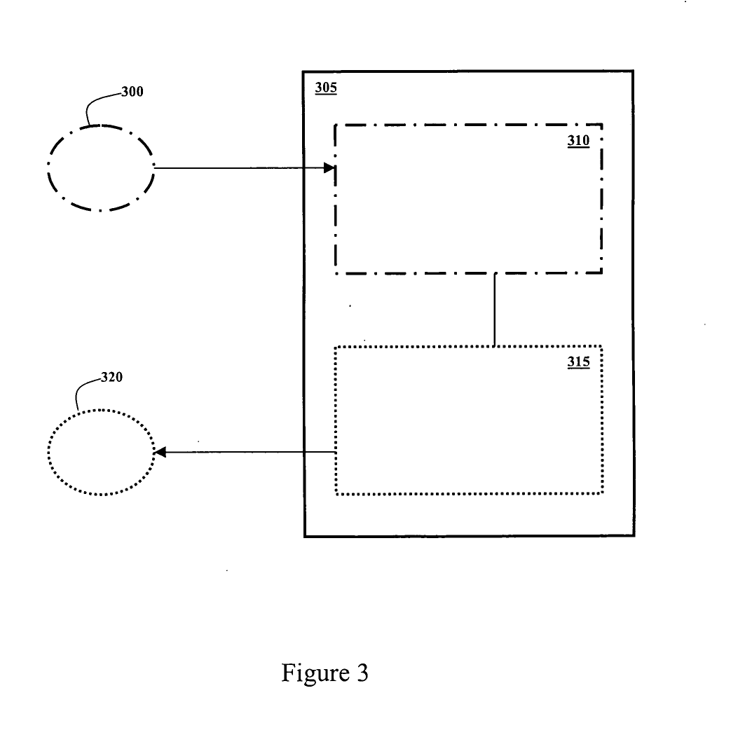

FIG. 3 is a generic embodiment 305 of the present invention. The initial data entry comes from input device 300 and the first sub-unit 310 of the present system is adapted to be compatible with, and accept the data from, the input device 300, no matter what type of device is used; fax, e-mail, webpage, etc. In response to the initial data entry, the second sub-unit 315 builds a record for the patient and sends out at least one reminder message to the patient's output device 320, in a format that is compatible with the output device. If the patient wishes to receive their reminder messages by telephone, then telephone calls are sent. If the patient wishes to receive their reminder message by e-mail, then e-mail messages are sent to the patient. No matter what type of input and output devices the present system is used with, the concept of sending important reminder messages to the patient remains the same. This generic embodiment 305 can receive and send messages in any known format, including text messaging. Thus the present system can be adapted to use the format that is most likely to result in the patient actually receiving the reminder messages.

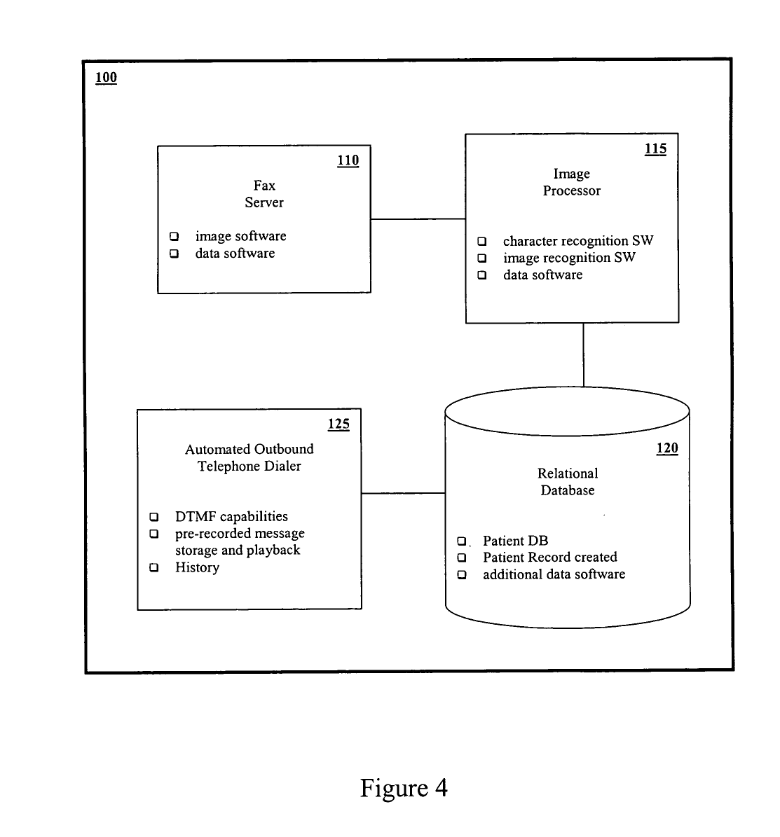

FIG. 4 is a block diagram the preferred embodiment 100, wherein the initial data entry is a fax and the reminder messages are sent via telephone. The Fax Server 110 receives the initial data entry (fax) and includes hardware and software for initial processing of the information in the fax that it receives. The Fax Server 110 also includes special data processing software for establishing initial data fields. In embodiments where e-mail or a form from a website is the initial data entry process, the Fax Server 110 is replaced with a web server that has similar capabilities. The Image Processor 115 includes hardware and software for character recognition, image recognition and for processing the initial fields. The Relational Database 120 includes a database of patient records, a module for creating Patient Records, and additional data processing software that adds fields to each record that assists the telephone dialer. The Automated Outbound Telephone Dialer 125 includes hardware and software for producing DTMF signals, storing and playing pre-recorded messages and creating a history of telephone calls.

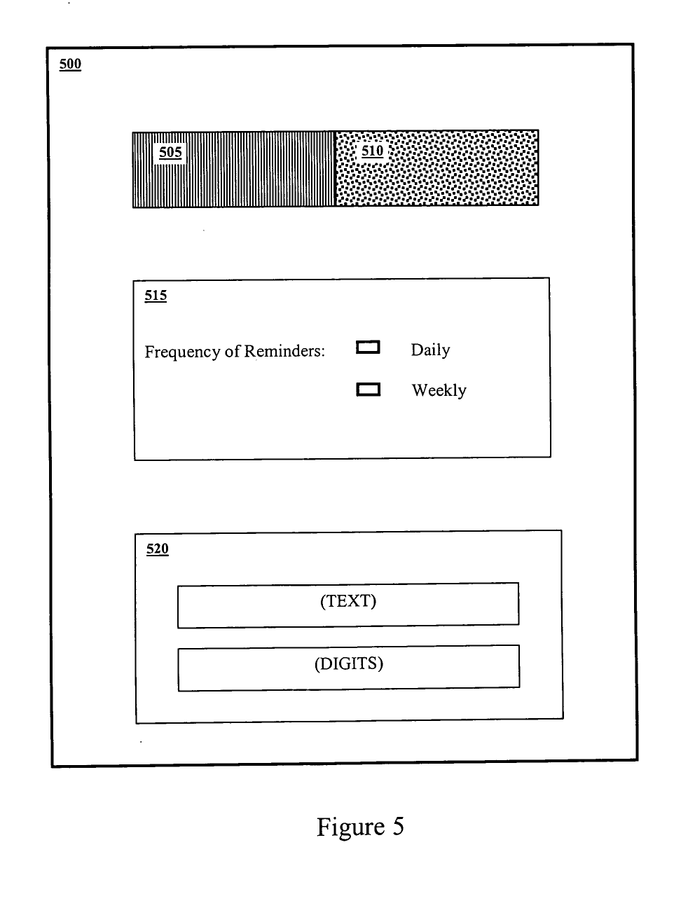

FIG. 5 shows an exemplary action form 500 that can be faxed into the preferred embodiment of the present integrated response system. Information on the action form 500 can be provided as a bar code 505, a three dimensional code 510, or other type of coding. The physical location of check marks or darkened ovals, as is shown in window 515, can also be used to provide instructions to the present system. Other locations on the action form 500 may also be designated for entering text and/or digits, as in window 520. The most important information that the system must be gather relates to what reminders messages need to be sent and how to send the messages to the patient. No matter what type of initial data entry is used, the present system extract the important information and builds a record for the patient that results in the patient receiving the requested reminders, at the times requested and in the requested format.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A system for reminding a patient of a doctor's instructions, wherein the system causes one or more reminder messages to be sent to the patient in response to the doctor filling out an action form and faxing the action form from a fax machine of the doctor to the present system, the system comprising:
a fax server that is adapted for connection to a telephone line, wherein the fax server receives the action form from the fax machine in the form of image data and converts the image data into an image file;
an image processor that is connected to the fax server, wherein the image processor receives the image file from the fax server and uses recognition software to identify multiple informational fields within the image file;
a relational database that is connected to the image processor, wherein the relational database receives the informational fields that were identified by the image processor, creates a record for the patient and uses the informational fields to populate the patient's record; and,
an automated, outbound telephone dialer that is adapted for connection to a second telephone line and is connected to the relational database, wherein the telephone dialer receives instructions from the relational database and in response to the instructions, places one or more telephone calls to a telephone of the patient at pre-defined times and, upon connection of each telephone call, plays at least one pre-recorded message for the patient to hear, wherein each pre-recorded message includes at least one reminder to the patient regarding the doctor's instructions.

2. The system of claim 1, wherein the fax server is adapted for connection to more than one telephone line.

3. The system of claim 1, wherein the image file created by the fax server is a .tif image file.

4. The system of claim 1, wherein the recognition software used by the image processor includes optical character recognition (OCR) software, image character recognition (ICR) software, and o m recognition (OMR) software.

5. The system of claim 1, wherein after the relational database creates the patent's record, the database adds additional fields to the patient's record that assist in a scheduling of the one or more telephone calls that are placed to the patient.

6. The system of claim 1, wherein the automated, outbound telephone dialer includes a compliance module that records a date, a time and other information regarding each successfully completed telephone call.

7. The system of claim 1, wherein the automated, outbound telephone dialer is replaced with a second fax server and the second fax server receives instructions from the relational database, and in response to the instructions, the second fax server sends one or more fax transmissions to a fax machine of the patient at pre-defined times and, wherein each fax transmission includes at least one reminder for the patient regarding the doctor's instructions.

8. The system of claim 7, wherein the second fax server includes a compliance module that records a date, a time and other information regarding each successfully completed fax transmission.

9. The system of claim 1, wherein the automated, outbound telephone dialer is replaced with a web server and the web server receives instructions from the relational database, and in response to the instructions the web server sends one or more e-mail messages to a computer of the patient at pre-defined times and, wherein each e-mail message includes at least one reminder for the patient regarding the doctor's instructions.

10. The system of claim 9, wherein the web server includes a compliance module that records a date, a time and other information regarding each successfully sent e-mail message.

11. A system for reminding a patient of a doctor's instructions, wherein the system causes one or more reminder messages to be sent to the patient in response to the doctor filling out an electronic action form and sending the action form from a doctor's computer to the present system, the system comprising:
a web server that is adapted for connection to a network, wherein the web server receives the electronic action form from the computer in the form of digital data, uses the digital data to create a data file, and identifies multiple informational fields within the data file;
a relational database that is connected to the web server, wherein the relational database receives the informational fields from the web server, creates a record for the patient and uses the informational fields to populate the patient's record; and,
an automated, outbound telephone dialer that is connected to the relational database, wherein the telephone dialer receives instructions from the relational database and in response to the instructions, places one or more telephone calls to a telephone of the patient at pre-defined times and, upon connection of each telephone call, plays at least one pre-recorded message for the patient to hear, wherein each pre-recorded message includes at least one reminder to the patient regarding the doctor's instructions.

12. The system of claim 11, wherein the network the web server is connection to is the Internet.

13. The system of claim 11, wherein the data file created by the web server is an XML file.

14. The system of claim 11, wherein after the relational database creates the patent's record, the database adds additional fields to the patient's record that assist in a scheduling of the one or more telephone calls that are placed to the patient.

15. The system of claim 11, wherein the automated, outbound telephone dialer includes a compliance module that records a date, a time and other information regarding each successfully completed telephone call.

16. The system of claim 11, wherein the automated, outbound telephone dialer is replaced with a fax server and the fax server receives instructions from the relational database, and in response to the instructions, the fax server sends one or more fax transmissions to the a fax machine of the patient at pre-defined times and, wherein each fax transmission includes at least one reminder for the patient regarding the doctor's instructions.

17. The system of claim 16, wherein the fax server includes a compliance module that records a date, a time and other information regarding each successfully completed fax transmission.

18. The system of claim 11, wherein the automated, outbound telephone dialer is replaced with a second web server and the second web server receives instructions from the relational database, and in response to the instructions the second web server sends one or more e-mail messages to a patient's computer at pre-defined times and, wherein each e-mail message includes at least one reminder for the patient regarding the doctor's instructions.

19. The system of claim 18, wherein the second web server includes a compliance module that records a date, a time and other information regarding each successfully sent e-mail message.
